(19) United States
(12) Patent Application Publication
(10) Pub. No.: US 2009/0034080 A1
(43) Pub. Date: Feb. 5, 2009

(54) OPTICAL SYSTEM

(76) Inventor: Cheng-Hao KO, Zhudong Town (TW)

Correspondence Address: SINORICA, LLC, 528 FALLSGROVE DRIVE, ROCKVILLE, MD, 20850, US

(21) Appl. No.: 12/180,567

(22) Filed: Jul. 28, 2008

(30) Foreign Application Priority Data
Aug. 3, 2007 (TW) 096128494

(51) Int. Cl. G02B 5/18

(52) U.S. Cl. 359/572

(57) ABSTRACT

The invention concerns an optical system. The optical system comprises an input for receiving an optical signal, a predetermined output plane, and a diffraction grating for separating the optical signal received at the input into spectral components thereof. The grating has a diffraction surface, which is formed by a photolithography process.

### BACKGROUND OF THE INVENTION

1. Field of the Invention

The present invention relates to an optical system and, more particularly, to an optical system made by a process of implementing a photolithography technology.

2. Description of the Related Art

A spectrometer is typically implemented to measure photometry with regard to radiation sources, and a grating in such spectrometer is a component for dispersing a multi-frequency radiation. Instruments such like are extensively applied to deal with complex measurement tasks for acquiring accurate results. However, such instruments are currently disadvantageous by: (a) bulkiness resulted in great cost and using limitedly at fixed locations, (b) time consumption for wideband spectrum measurement, and (c) demand for skilled operators because cautious operation is necessary.

U.S. Pat. No. 5,550,375 provides an infrared-spectrometric sensor 100 for gases, as shown in FIG. 1, which comprises a microstructured body having a reflective grating 110, a multi-frequency IR radiation source 120, and a radiation receiver 130 for receiving IR of a fixed range of wavelength. Nevertheless, this infrared-spectrometric sensor is merely capable of measuring spectrums within a narrow wavelength range. In a case that multiple components are to be analyzed, the spectral signals would be absorbed at several different wavelengths, not only in the infrared region. Therefore, the applications of this prior spectrometric sensor are limited.

A simultaneous spectrometer 200 is another device for detecting radiation sources, as shown in FIG. 2. It comprises an entrance slit 200, a concave grating 210 capable of forming holographic images, and a photoelectric diode array 230. The aforementioned components are fixedly positioned and immovable while these components present the reliable advantages such as high accuracy and excellent optical efficiency. In such spectrometer, the photoelectric diode array is applied with limitations because the photoelectric diode array is substantially a flat plane, while the focuses of the spectrometer are distributed on a curved surface and, more particularly, on the Rowland circle. One preferred application of such simultaneous spectrometer is to increase the radius of the Rowland circle so that the distribution of the focuses can be a planar distribution approximately. However, this approach consumes large space and requires a large detector. An alternative solution is as the disclosure of U.S. Pat. No. 6,005,661, wherein a great quantity of optical fibers are employed to lead out signals with diverse wavelengths focused on the Rowland circle. Although such approach can compromise the disadvantages of photoelectric diode array, problems such as energy lost and degraded resolution may also occur when the focused signals are led out by the optical fibers.

Instead, a diffraction grating generating linear outputs is a preferable option for an optical system. As shown in FIG. 3A, the inventor of U.S. Pat. Nos. 4,695,132 and 4,770,517 provides a laser scanning system 300, which implements one or more f θ lenses 310 to focus scattered light beams on a linear output plane 320. As shown in FIG. 3B, U.S. Pat. No. 6,650,413 provides a spectrometer 301 using a diffraction grating 311 and comprising an assembly of a collimator 313 and a correcting lens 315 for focusing the output spectral components on an image plane 321 in accordance with an f sin (θ) distribution.

However, the above-mentioned inventions are all systems with complex structures and therefore fail to achieve the objective of microminiaturizing an optical system to become portable.

### SUMMARY OF THE INVENTION

It is one objective of the present invention to provide a diffraction grating for being applied to an optical system, wherein the diffraction grating is made by a photolithography process and has a microminiaturized volume that facilitates portability.

It is another objective of the present invention to provide an optical system, which can be mass-produced with reduced manufacturing costs and is feasible for long-term use.

To achieve these and other objectives, the present invention provides an optical system that comprises an input for receiving an optical signal, a predetermined output plane, and a diffraction grating. The diffraction grating has a diffraction surface for separating the optical signal received from the input into a plurality of spectral components to be focused on the predetermined output plane, wherein the diffraction surface is made by a photolithography process.

To achieve these and other objectives, the present invention provides an optical method, which is particularly a method for producing an optical system by providing a base, a cover positioned above the base, and an input for receiving an optical signal, and then defining a predetermined output plane, and then configuring a diffraction grating, which has a diffraction surface made by a photolithography process.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein

FIG. 1 is a schematic drawing illustrating a prior infrared-spectrometric detector,

FIG. 2 is a schematic drawing illustrating a prior simultaneous spectrometer,

FIG. 3A is a schematic drawing illustrating a prior laser scanning system,

FIG. 3B is a schematic drawing illustrating a prior spectrometer,

FIG. 4 is a sectional view of an optical system according to one preferred embodiment of the present invention,

FIG. 5 is a schematic drawing of the optical system according to the aforementioned preferred embodiment of the present invention,

FIG. 6 is a schematic drawing of a diffraction grating according to the aforementioned preferred embodiment of the present invention,

FIG. 7 is a schematic drawing showing the formation of the diffraction grating according to one preferred embodiment of the present invention,

FIG. 8 is a sectional view of the optical system according to another preferred embodiment of the present invention,

FIGS. 9A and 9B both illustrate the positioning of the cover according to another embodiments of the present invention, and

FIG. 10 illustrates the diffraction grating according to another preferred embodiment of the present invention.

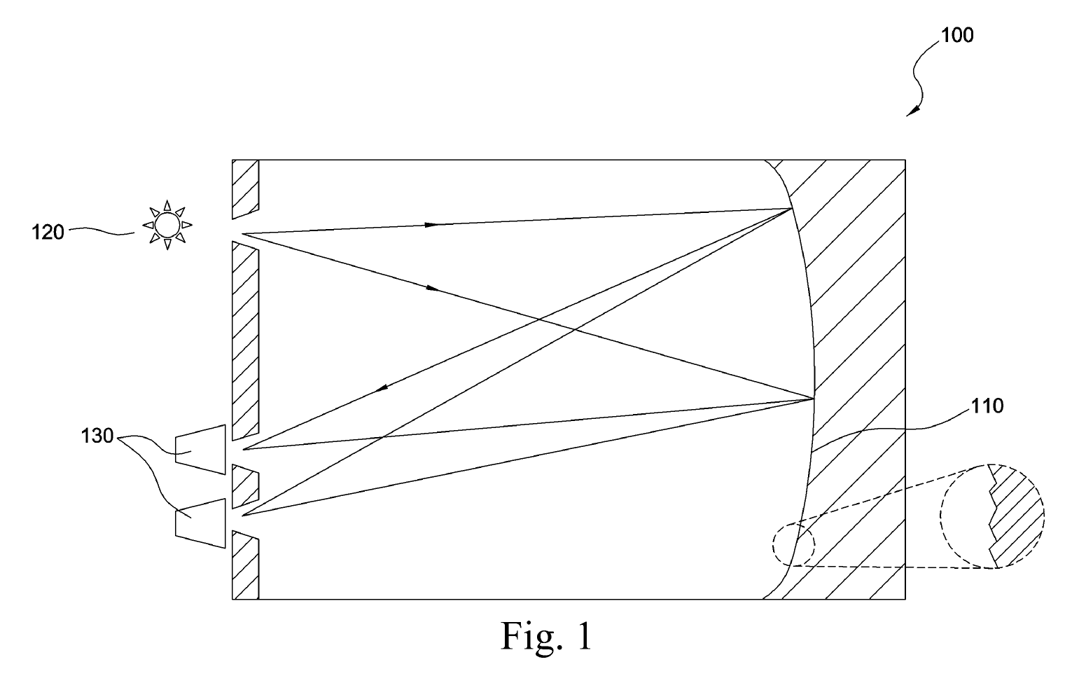

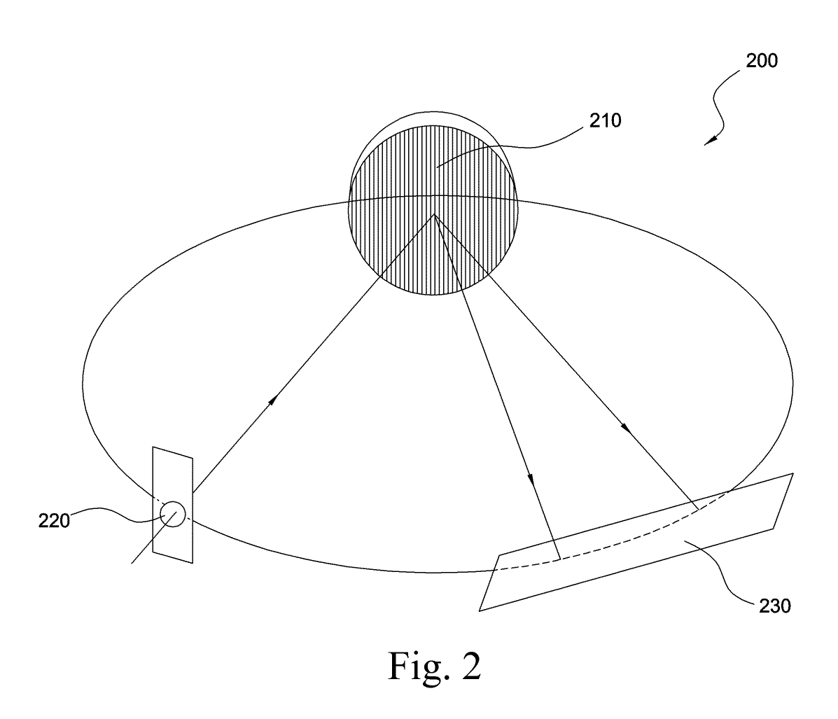

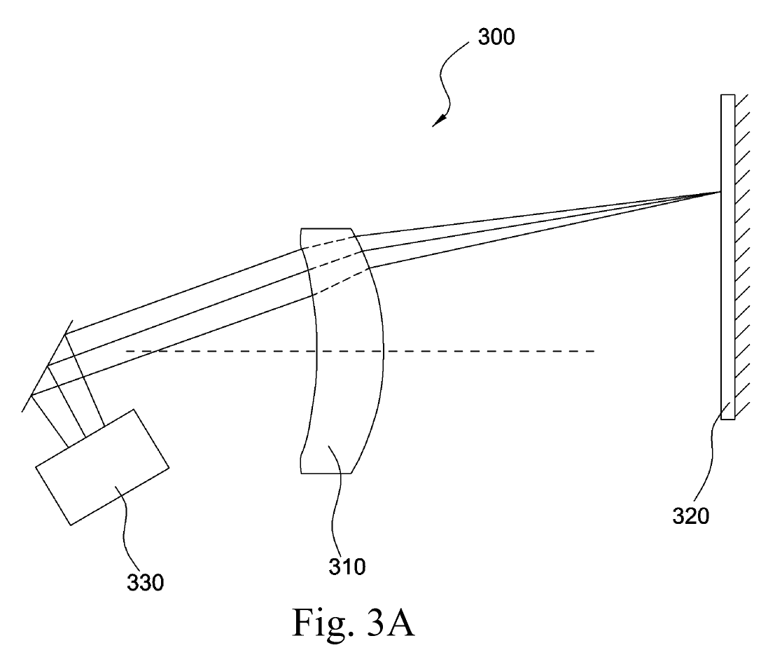

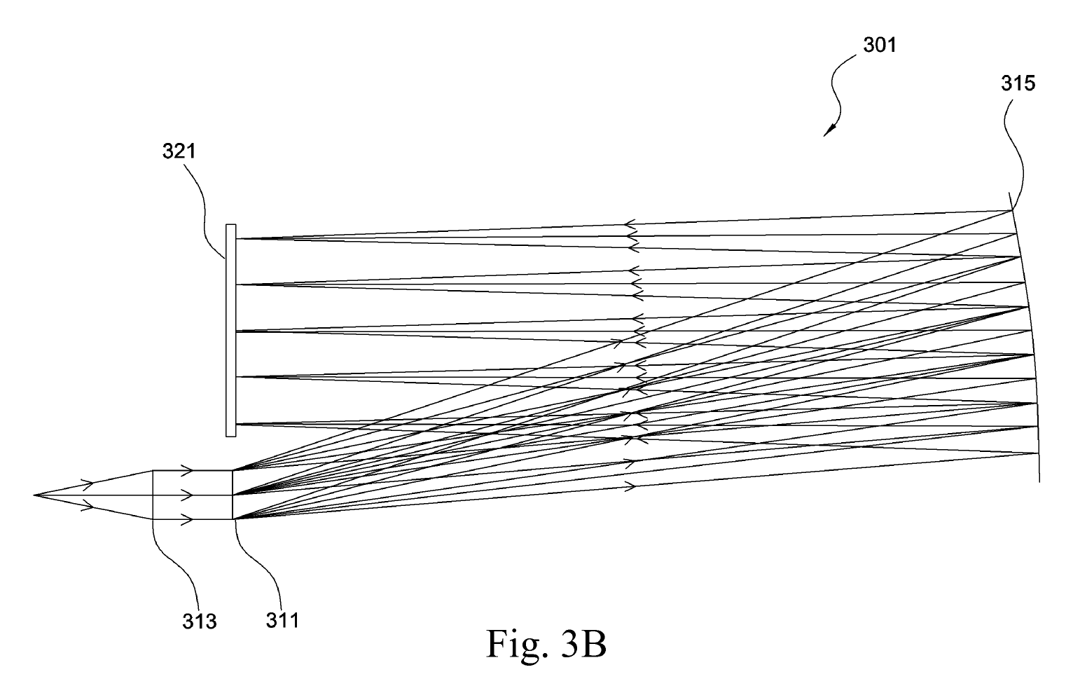

### DETAILED DESCRIPTION OF THE EMBODIMENTS

The technical features adopted in the present invention in the attempt to achieve the aforementioned effects and objectives will be described in detail in company with following preferred embodiments and the accompanying drawing so as to be clearly comprehended.

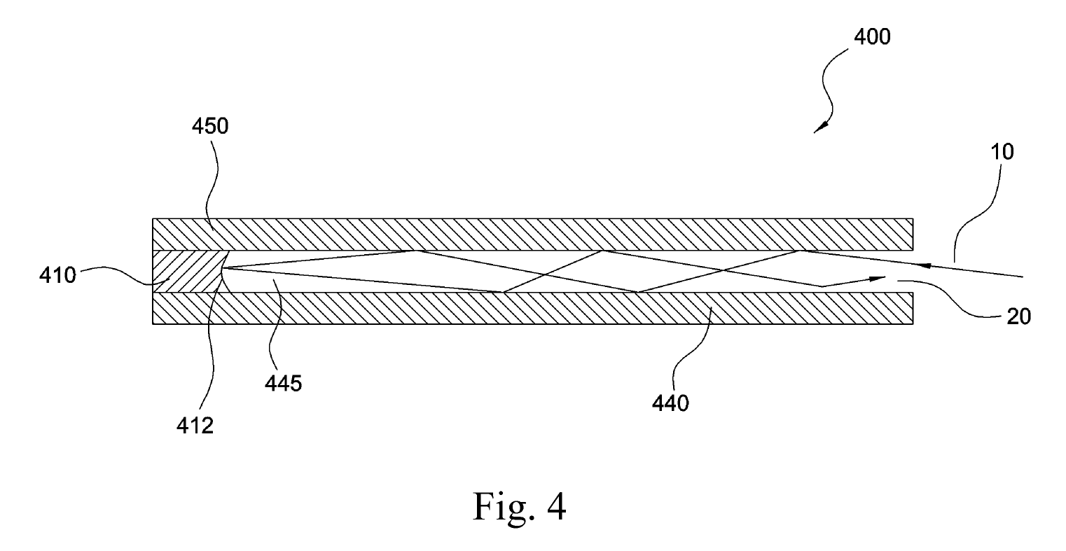

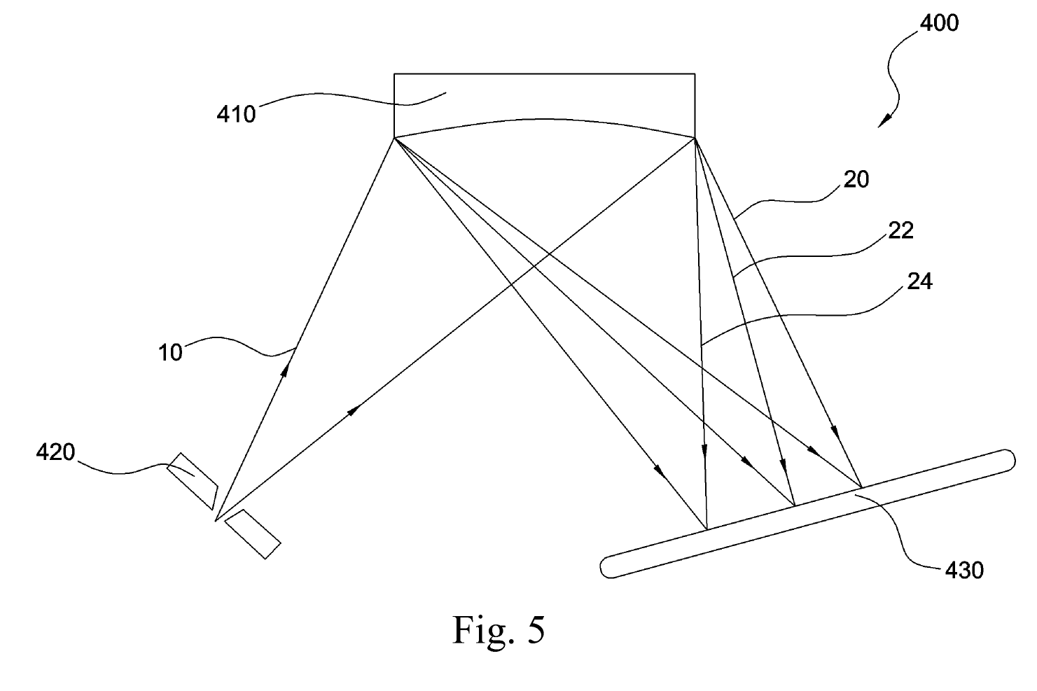

Please refer to FIGS. 4 and 5, wherein a preferred embodiment of the present invention is provided. Therein, an optical system 400 comprises a base 440, a cover 450, an input 420, a predetermined output plane 430, and a diffraction grating 410.

An inner space 445 is formed between the base 440 and the cover 450. The diffraction grating 410 is settled on the base 440 and has a diffraction surface 412 that faces the inner space 445.

The diffraction grating 410 has the diffraction surface 412 for separating an optical signal 10 entering the optical system 400 into a plurality of spectral components, such as 20, 22, and 24, which have different wavelengths. These spectral components are focused on the predetermined output plane. When being focused, the spectral components presented on the predetermined output plane have the FWHM (full width at half maximum) smaller than or equal to the predetermined wavelength resolution.

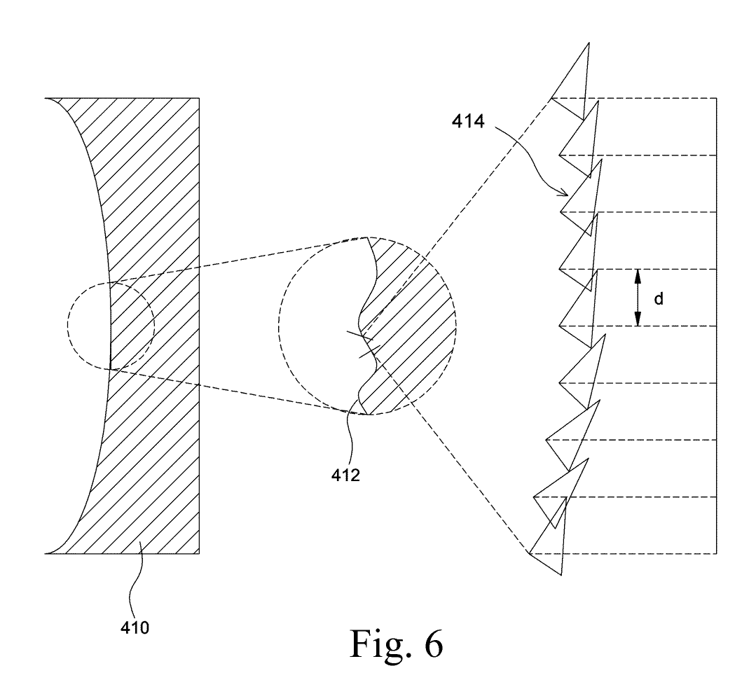

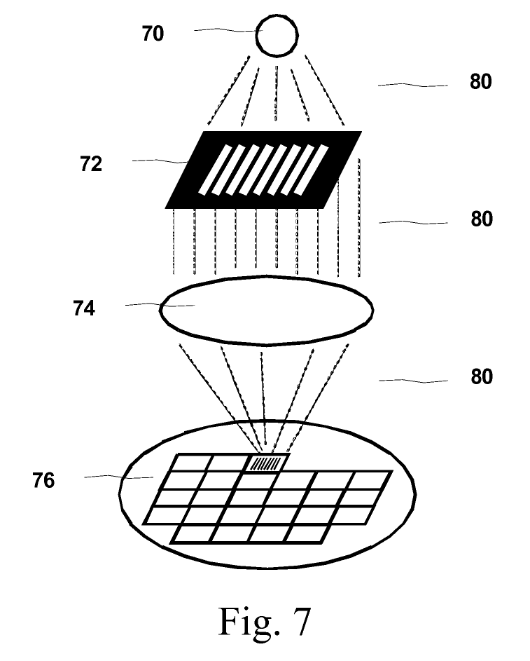

As shown in FIG. 6, the diffraction surface 412 of the diffraction grating 410 has a periodic structure 414 made by a photolithography process. According to FIG. 7, a designed periodic pattern is used to make a photomask 72 and then a light 80 from an exposure source 70 passes through transparent regions on the photomask 72 and proceeds to passing a lens 74 so as to react with a photoresist pre-applied on a surface of a substrate 76 upon an optical imaging principle. The above process also referred to as exposure. Subsequently, after the exposed and non-exposed photoresist portions are chemically processed, the pattern on the photomask 72 can be transferred to the substrate 76 so as to form the periodic structure on the diffraction surface 412. In such photolithography process, the substrate 76 may be made of a III-V semiconductor, a Group IV element, glass, plastic or a metal.

The diffraction surface 412 is a reflection surface, which may be formed by plating the diffraction grating 410 with a metal film through a method selected from the group consisting of vapor deposition, sputtering, evaporation, polishing, and electroplating. The metal film may be formed with silver, gold, aluminum, platinum, titanium or nickel.

The input 420 is typically a slit where through an optical signal 10 is allowed to enter the inner space 445. The input 420 may alternatively be an end of an optical fiber formed by a fiber core so that the optical signal 10 can be transmitted through the optical fiber into the optical system 400. The slit may be made by the aforementioned photolithography process, EDM (electro-discharging machining), laser-writing, slicing, or may be made by a molding process.

The predetermined output plane may be a flat plane or in any other geometric shape, such as a curved surface or a wavy surface. A detector is provided on the output plane to receive the focused spectral component signals. The detector is a light detector having a photodiode array, such as a CCD (charge-coupled device) or a CMOS (Complementary Metal-Oxide-Semiconductor) image sensor.

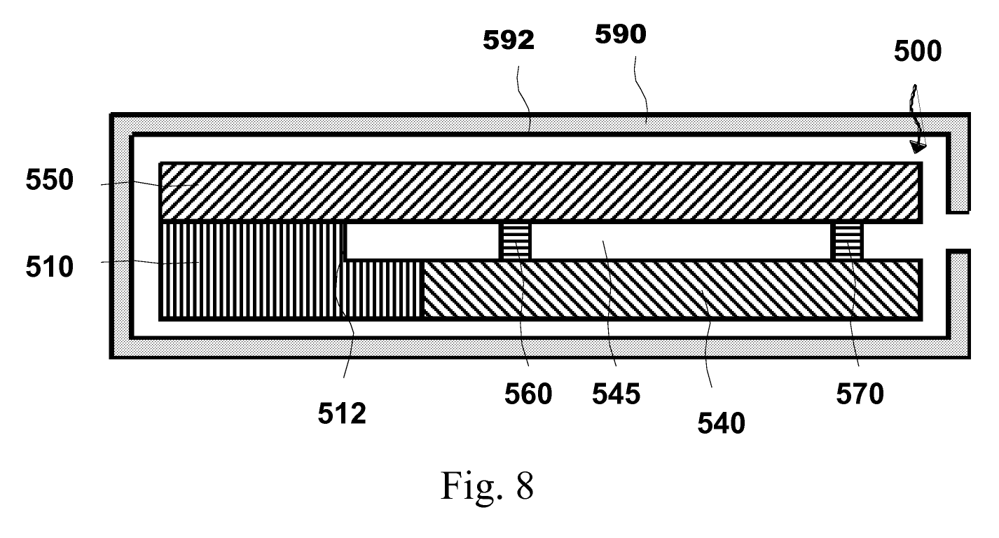

According to another preferred embodiment of the present invention as shown in FIG. 8, an optical system 500 comprises a base 540, a cover 550, and a diffraction grating 510. An inner space 545 is formed between the base 540 and the cover 550. Therein, the base 540 and the cover 550 may be made of an identical material or different materials selected from a III-V semiconductor, a Group IV element, glass, plastic or a metal.

A plurality of spacers 560 are sandwiched between the base 540 and the cover 550 to uphold the inner space 545 and separate the base 540 from the cover 550 for a desired distance. Besides, a plurality of light shielding elements 570 are also sandwiched between the base 540 and the cover 550 for shielding superfluous lights.

The spacers 560 and the light shielding elements 570 are formed on either the base 540 or the cover 550 by a molding process or a photolithography process. Therein, the photolithography process for making the spacers comprises applying a layer of a photoresist on one of the base 540 and the cover 550, patterning the photoresist, and solidifying the patterned photoresist so as to form the spacers 560.

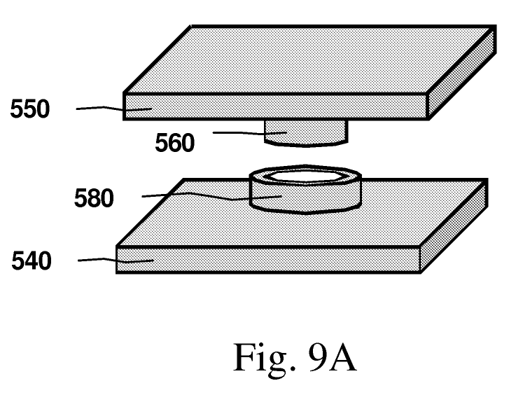

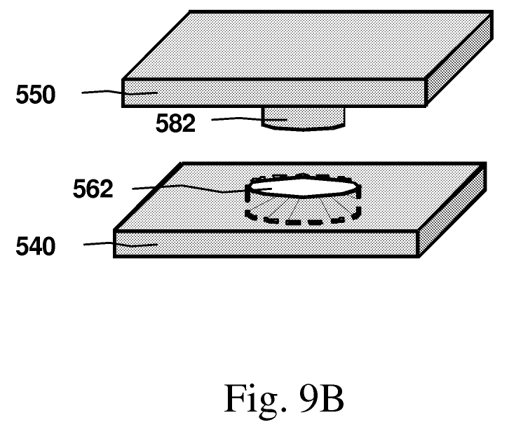

According to FIGS. 9A and 9B, besides being provided alone, each of the spacers 560 or 582 may be provided together with a first positioning part 580 or 562 that is formed on the other base 540 or the cover 550 positionally corresponding to the spacer 560 or 582, as shown in FIGS. 9A and 9B. Accordingly, by combining the first positioning part 580 or 562 to the spacer 560 or 562, the cover 550 is guided and properly positioned on the base 540.

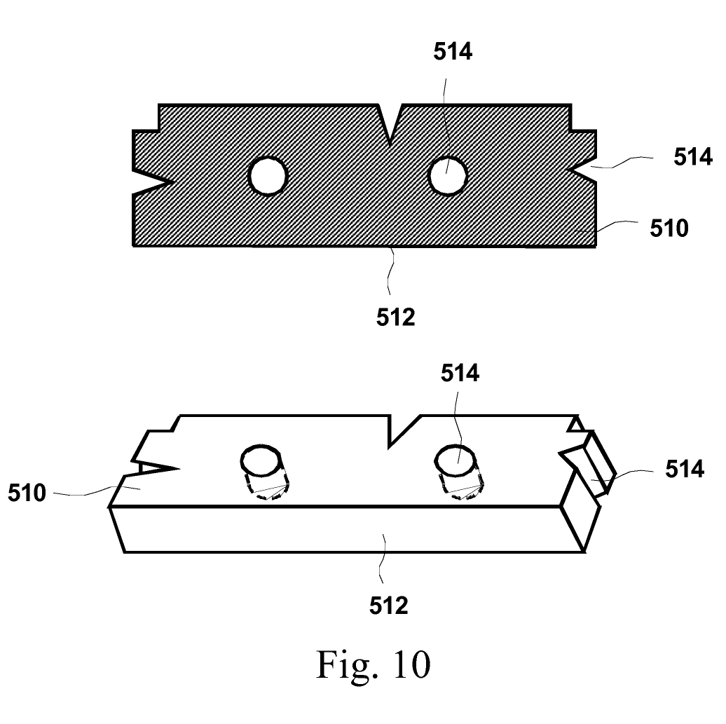

As shown in FIG. 10, at least one recess 514 is provided on a contacting surface of the diffraction grating 510 abutting the base 540 or the cover 550. Meanwhile, at least one second positioning part (not shown) positionally corresponding to the recess 514 is provided on a contacting surface of the base 540 or the cover 550 abutting the diffraction grating 510. Accordingly, by combining the recess 514 to the second positioning part, the diffraction grating 510 is guided and properly settled on the base 540 or the cover 550.

At least a first reflection layer is provided to cover a contacting surface of the base 540 facing the inner space 545. The first reflection layer is typically made of a metal. The metal, more particularly, is selected from one of the group consisting of silver, gold, aluminum, platinum, titanium and nickel. Besides, At least a second reflection layer is provided to cover a contacting surface of the cover 550 facing the inner space 545. The second reflection layer is typically made of a metal, and the metal is, more particularly, also selected from one of the group consisting of silver, gold, aluminum, platinum, titanium and nickel.

The diffraction grating 510 has a diffraction surface 512, whereon at least a third reflection layer is formed for covering it. The third reflection layer is made by plating a metal on the diffraction surface 512 to form a metal film. The metal is selected from one of the group consisting of silver, gold, aluminum, platinum, titanium and nickel.

One of the preferred embodiment of the constitution and arrangement of the first, second or the third reflection layers is a film of titanium of 50 nm overlaid by 200 nm of silver and then overlaid by 1 μm of silica sequentially. Besides, TiO2 or other dielectric materials can be substituted for the silica.

The film of titanium is not indispensable to the first and the second reflection layer, however, if the cover 450 or the base 440 is made of plastic rather than metal, for the titanium serves to bind the silver with the cover 450 or the base 440 when the cover 450 or the base 440 is metallic. So, whether the reflection layer contains the film of titanium depends on the material of the cover 450 or the base 440.

As shown in FIG. 8, a housing 590 is provided at an exterior of the optical system 500. The housing 590 has an inner surface 592, which is non-reflective or light absorbing so as to prevent an external light from disturbing the operation of the optical system 500.

The inner space 545 of the optical system 500 may be filled with air or a proper liquid, which has a refractive index greater than those of the base 540, the cover 550 and the grating 510.

According to one preferred embodiment of the present invention, a method for producing an optical system is provided, which comprises the steps of providing a base, positioning a cover above the base, providing an input for receiving an optical signal, defining a predetermined output plane, and configuring a diffraction grating, which has a diffraction surface made by a photolithography process.

According to the disclosed method for producing the optical system, at least one spacer is formed on either the base or the cover while at least one first positioning part is formed on the other cover or base whereupon the step of positioning the cover is achieved by combining the spacer and the first positioning part.

According to the disclosed method for producing the optical system, at least one recess is formed on a contacting surface of the diffraction grating abutting either the base or the cover while at least one second positioning part is formed on a contacting surface of the abutted the other cover or base whereupon the step of configuring the diffraction grating is achieved by combining the recess and the second positioning part.

Therefore, the diffraction grating of the present invention is applied to an optical system and made by a photolithography process with high accuracy. Besides, the diffraction grating of the present invention is so microminiaturized that mass production is practical, which results in reducing the costs of manufacturing.

Although the particular embodiments of the invention have been described in detail for purposes of illustration, it will be understood by one of ordinary skill in the art that numerous variations will be possible to the disclosed embodiments without going outside the scope of the invention as disclosed in the claims.

What is claimed is:

1. An optical system, comprising:
an input, for receiving an optical signal,
a predetermined output plane, and
a diffraction grating, having a diffraction surface made by a photolithography process for separating the optical signal received at the input into a plurality of spectral components, which are then focused on the predetermined output plane.

2. The optical system of claim 1, further comprising at least one detector provided on the predetermined output plane for detecting the spectral components on the predetermined output plane.

3. The optical system of claim 2, wherein the detector is a CCD (charge-coupled device) detector or a CMOS detector.

4. The optical system of claim 2, wherein the diffraction grating is made of a material selected from the group consisting of a III-V semiconductor, a Group IV element, glass, plastic and a metal.

5. The optical system of claim 1, wherein the diffraction surface is a reflective diffraction surface.

6. The optical system of claim 5, wherein the reflective diffraction surface is made by plating at least one metal film on the diffraction grating.

7. The optical system of claim 1, wherein the input is a slit.

8. An optical system, comprising:
a base,
a cover, positioned above the base and forming an inner space together with the base,
an input, for receiving an optical signal,
a predetermined output plane, and
a diffraction grating, having a diffraction surface made by a photolithography process for separating the optical signal received from the input into a plurality of spectral components, which are then focused on the predetermined output plane.

9. The optical system of claim 8, further comprising at least one spacer sandwiched between the base and the cover.

10. The optical system of claim 8, further comprising a light shielding element sandwiched between the base and the cover.

11. The optical system of claim 8, wherein the base and/or the cover is made of a material selected from the group consisting of a III-V semiconductor, a Group IV element, glass, plastic and a metal.

12. The optical system of claim 8, wherein a surface of the base facing the inner space is covered by a first reflection layer.

13. The optical system of claim 8, wherein a surface of the cover facing the inner space is covered by a second reflection layer.

14. The optical system of claim 8, further comprising a housing positioned at an exterior of the optical system and enclose the optical system.

15. A method for producing an optical system, comprising:
providing a base,
positioning a cover above the base,
providing an input, for receiving an optical signal,
defining a predetermined output plane, and
configuring a diffraction grating in the optical system, in which the diffraction grating has a diffraction surface made by a photolithography process for separating the optical signal received at the input into a plurality of spectral components, which are then focused in the predetermined output plane.

16. The method of claim 15, further comprising forming at least one spacer on either the base or the cover.

17. The method of claim 16, wherein the step of forming the spacer is conducted by a photolithography process or a molding process.

18. The method of claim 15, further comprising forming a recess on the diffraction grating.

19. The method of claim 16, further comprising forming a first positioning part on either the base or the cover, which is positionally corresponding to the spacer on the other cover or the base, whereby the step of positioning the cover is achieved by the spacer coordinating with the first positioning part.

20. The method of claim 18, further comprising forming a second positioning part on either the base or the cover, which is positionally corresponding to the recess, whereby the step of configuring the diffraction grating is achieved by the recess coordinating with the second positioning part.
